(19) United States
(12) Patent Application Publication
(10) Pub. No.: US 2009/0125235 A1
(43) Pub. Date: May 14, 2009

(54) Method of updating navigation map data

(75) Inventors: Hsiang-Yin Chen, Hsinchu City (TW); Chun-Ming Chen, Hsinchu City (TW)

Correspondence Address: RABIN & Berdo, PC, 1101 14TH STREET, NW, SUITE 500, WASHINGTON, DC, 20005, US

(73) Assignee: Altek Corporation, Hsinchu (TW)

(21) Appl. No.: 12/010,940

(22) Filed: Jan. 31, 2008

(30) Foreign Application Priority Data
Nov. 9, 2007 (TW) 096142561

(51) Int. Cl. G01C 21/28

(52) U.S. Cl. 701/210; 701/208

(57) ABSTRACT

A method of updating navigation map data obtains at least one corresponding coordinate position with movement of the global positioning system navigator by receiving at least one satellite positioning signal. When it is determined that a vehicle is traveling to a street intersection, at least one image of road scene is photoed, and the coordinate position of the street intersection is recorded. At the same time, a traveling route comprising the image is recorded according to all coordination positions received between intersections, and a street map, road type information, and road scene information in a map database are updated according to the traveling route, such that navigation map database is updated, navigation route accuracy is maintained, and scene navigation and other functions are implemented immediately without linking to a server.

### CROSS-REFERENCE TO RELATED APPLICATIONS

This non-provisional application claims priority under 35 U.S.C. §119(a) on Patent Application No(s). 096142561 filed in Taiwan, R.O.C. on Nov. 9, 2007, the entire contents of which are hereby incorporated by reference.

### BACKGROUND OF THE INVENTION

1. Field of Invention

The present invention relates to a method of updating map data. More particularly, the present invention relates to a method of updating global positioning system (GPS) navigation map data by means of road scene and positioning information.

2. Related Art

GPS is a precise positioning technology, for giving longitude and latitude coordinates to objects on earth surface. Development of GPS technology exceeds 20 years till now, at the beginning, the technology is developed for military purpose to position and navigate ships and aircrafts. A GPS navigator (receiver) receives satellite signals sent by a GPS satellite, so as to calculate its own position, and to perform GPS navigation by using a pre-built street map. With the increasing maturation of GPS technology and popularization of GPS equipments, the GPS technology has been widely applied in vehicle navigation. FIG. 1A is a navigation frame of a vehicle GPS navigator, in which the GPS navigator can program a proposed driving path through a path programming algorithm mechanism, thus providing reference for drivers. In order to make the navigation path be clearer, some GPS navigators make the navigation path partially enlarged as shown in FIG. 1B to 1C. At a complex intersection (e.g., a complex interchange), some navigation systems provide manually drawn three-dimensional figures as FIG. 1D to 1F, so as to prevent the user from going wrong because of route confusion. Some other navigation systems use scene pictures as shown in FIG. 1G to assist driving navigation.

For the above navigation systems, no matter schematic plane view, schematic three-dimensional view, or scene picture is used for navigation and indication, the user needs to link to the Internet regularly (or use mobile phone) to update the built-in map database, so as to maintain the navigation accuracy all the time. However, for most of the users, usually because the map database is not regularly updated, or the map data content provided by the server does not match with the practical road situation, the navigation accuracy is reduced. Accordingly, the present invention provides a method of updating map database of GPS navigation, for accurately updating the map data on real time, so as to ensure that the map data totally matches with the practical road situation.

### SUMMARY OF THE INVENTION

In view of the above mentioned, the present invention is directed to a method of updating navigation map data. A satellite navigator having a digital lens is used to execute the method, when it is determined that a vehicle is traveling to a street intersection, a road scene picture is took, and a map database is updated according to a received coordinate portion and the corresponding road scene picture, so as to achieve a function of updating the map database without additional connecting to a server.

In order to achieve the above objective, the method of updating navigation map data of the present invention includes the following steps. First, at least one GPS signal is received to obtain at least one corresponding coordinate position with movement of the global positioning system navigator. Then, when it is determined that the vehicle is traveling to a street intersection, at least one image of road scene picture is took, and the coordinate position of the street intersection is recorded. Next, according to a plurality of sets of coordinate positions received before traveling to a next street intersection, a traveling route comprising the image is recorded. Finally, a comparison is made to find whether the map database includes the traveling route, and if not, the map database is updated.

In the method of updating navigation map on real time, according to a preferred embodiment of the present invention, the map database includes a street map, road type information, and road scene information.

In the method of updating navigation map on real time, according to a preferred embodiment of the present invention, the ways of determining the position to be the street intersection are as follows. First, during a predetermined period, calculate the variance of the received coordinate position, and then determine that the vehicle is traveling to the street intersection currently if the variance does not exceed a predetermined value. Second, detect the change of the traveling direction with an accelerometer or a gyro disposed in the satellite navigator, thereby determining that the vehicle is traveling to the street intersection. Third, determine that the vehicle is traveling to the street intersection currently through the information included in the map database.

In view of the above mentioned, in the present invention, the road scene data in the map database is updated by the road scene took at the street intersection, the traveling route is recorded according to the coordinate positions received between two intersections, and the street map in the map database is updated according to the traveling route, so as to update the map database according to driving course without connecting to the server, thereby updating scene navigation image from time to time, such that the scene navigation becomes more veritable.

### BRIEF DESCRIPTION OF THE DRAWINGS

The present invention will become more fully understood from the detailed description given herein below for illustration only, and thus are not limitative of the present invention, and wherein:

FIGS. 1A to 1G are schematic views of conventional vehicle navigation;

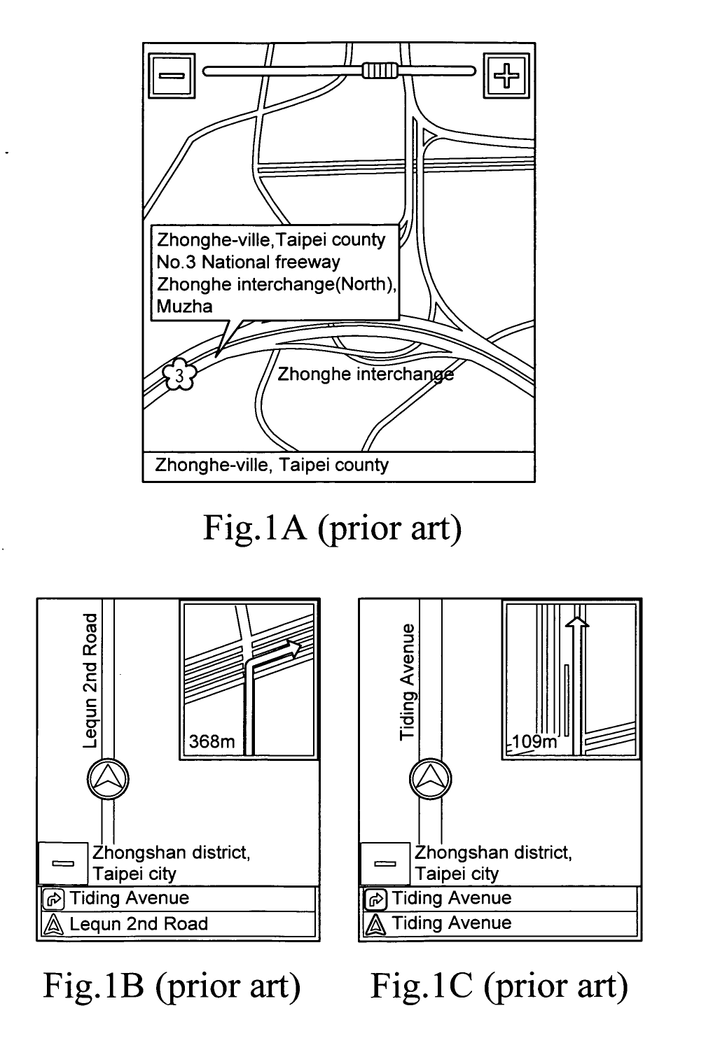

FIG. 2A is a schematic front view of a satellite positioning navigator according to a preferred embodiment of the present invention;

FIG. 2B is a schematic back view of the satellite positioning navigator according to a preferred embodiment of the present invention;

FIG. 3 is a flow chart of a method of updating navigation map data of the present invention;

FIG. 4A is a schematic view of the road scene took by the satellite positioning navigator according to a preferred embodiment of the present invention;

FIG. 4B to 4D is a schematic view of the map database corresponding to the coordinate position of the road scene of FIG. 4A; and

FIG. 4E to 4H is a schematic view of updating the database information of FIG. 4B according to the traveling route.

### DETAILED DESCRIPTION OF THE INVENTION

The method of updating the navigation map data provided by the present invention is described in detail in the following preferred embodiment. However, concept of the present invention can also be used in other scope. The exemplified embodiments are only used to illustrate the objective and the executing method of the present invention, and are not used to limit the scope.

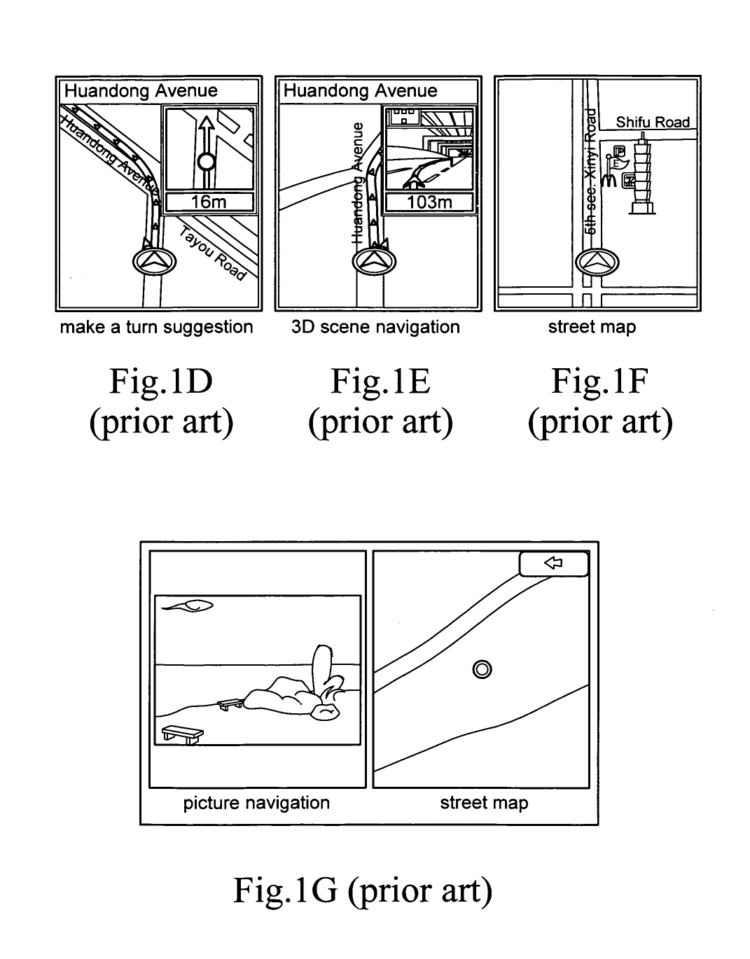

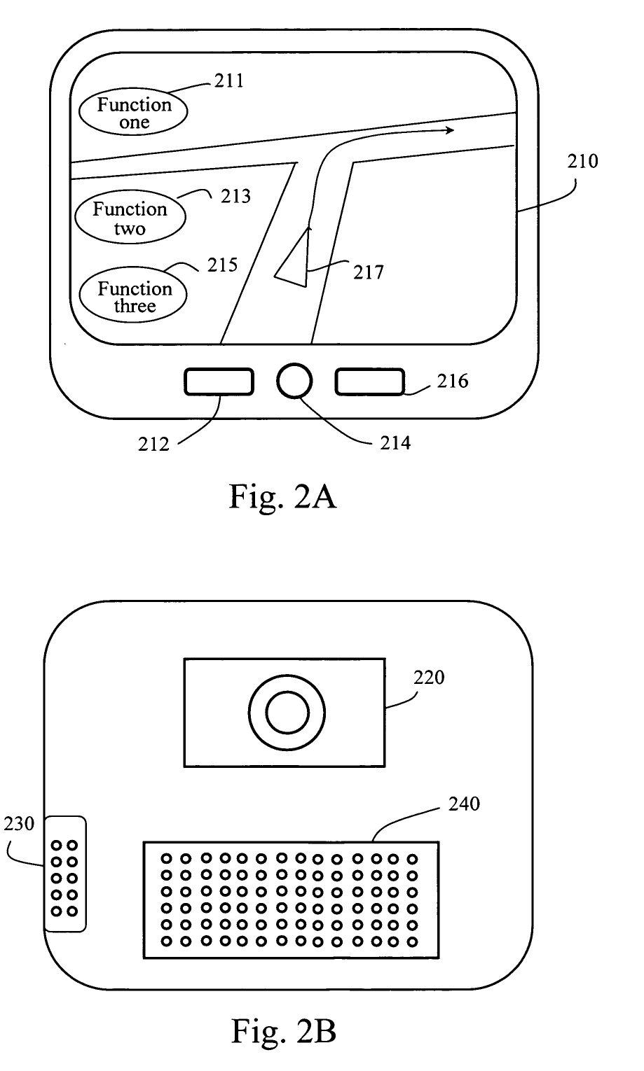

Before the detailed description of the method of updating navigation map data (hereafter referred to as the method) of the present invention, firstly, hardware realizing the method is introduced. FIG. 2A is a schematic front view of the satellite positioning navigator according to a preferred embodiment of the present invention. Referring to FIG. 2A, the satellite positioning navigator has a human-machine interface 210, for displaying a map and a navigation route. In the drawing, a triangle represents a position 217 of a user, and the user obtains a reference traveling direction by viewing the programming route on the map (for example curve segment connecting to the position 217). The user can use screen function menus (211, 213, and 215) or function selecting keys (212, 214, and 216) to control execution of various navigation functions.

FIG. 2B is a schematic back view of the satellite positioning navigator according to a preferred embodiment of the present invention. Referring to FIG. 2B, a digital lens 220 is embedded on a back surface of the satellite positioning navigator. The digital lens 220 is a digital lens capable of adjusting photographic angle. When the satellite positioning navigator is placed on a vehicle windscreen or a position reachable by driving visual line, the street scene in front of the vehicle can be took by adjusting the digital lens 220. The digital lens 220 can be, for example, a movable wide-angle lens or a non-movable wide-angle lens. The wide-angle lens can eliminate the photographic viewing angle problem, such that the street scene in front of the vehicle can be took without generating dead angle of the photoed image. In some other embodiments, the screen function menus (211, 213, and 215), the function selecting keys (212, 214, and 216), a microphone 230, or other acoustic control equipments can be used to adjust the photographic angle of the digital lens 220. When the driving navigation is started, instruction voice can be played by using a loudspeaker 240 of the satellite positioning navigator, so as to perform voice navigation.

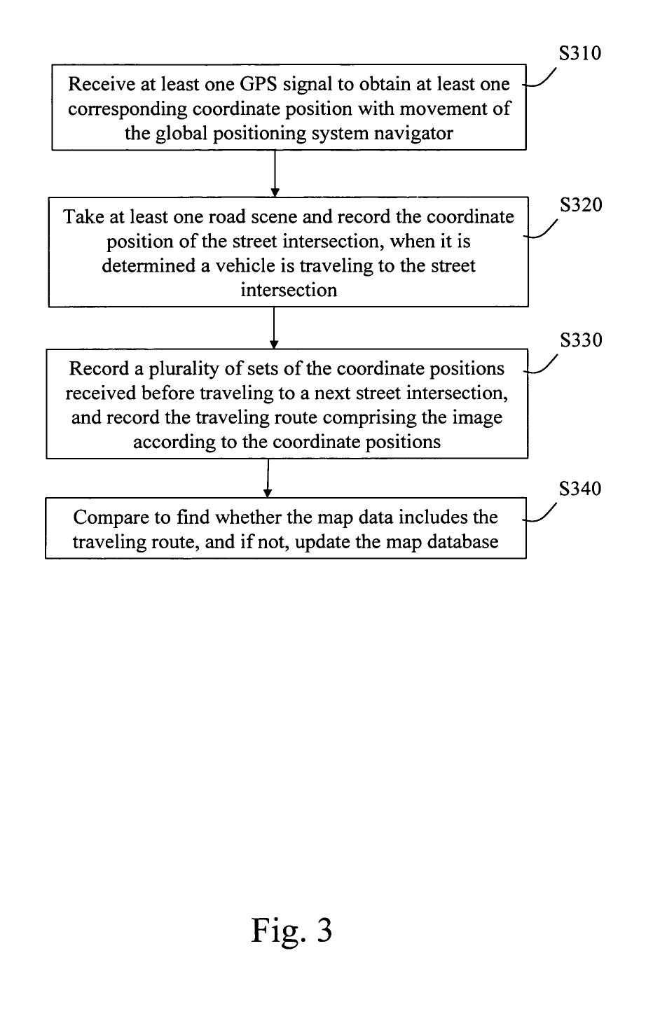

FIG. 3 is a flow chart of the method of updating navigation map data of the present invention. Referring to FIG. 3, in this method, the satellite positioning navigator is used to detect the driving course (that is, the position coordinates are obtained through the GPS signal to obtain the driving route), then, the photographic angle of the digital lens can be adjusted to take the road scene, and the road scene can be, for example, a dynamic image (i.e., an audio/video file) or a static image (i.e., a picture) of the street scene photoed in front of the vehicle. Then, according to the road scene and the received coordinate position, the map database is maintained. The method includes the following steps. Firstly, at least one GPS signal is received to obtain at least one corresponding coordinate position with movement of the global positioning system navigator(step S310). Next, when it is determined that a vehicle is traveling to the street intersection, at least one road scene is took, and the coordinate position of the street intersection is recorded (step S320). Then, according to a plurality of sets of the coordination positions received before traveling to a next street intersection, the traveling route comprising the image is recorded (step S330). Finally, a comparison is made to find whether the map database includes the traveling route, and if not, the map database is updated (step S340).

In a preferred embodiment of the present invention, for example, a vehicle is driven in urban area or common road, the user can use a user interface to adjust to photo the static image (picture) or to photo the dynamic image (audio/video file), providing for the satellite positioning navigator to automatically update the map data comprised in the map database, or providing for the scene navigation purpose. The map database includes a street map, road type information, and road scene information. The user can select maps with different visual scopes as the street map displayed on the screen, or can automatically select the map with a suitable size by using distance between the initial point and the destination. The road types include street, alleyway, intersection, and traffic circle etc, and each different road has a corresponding road type. In the preferred embodiment, a corresponding road type (including location, road type and width, and record relative to the road) is given to each street and intersection, so as to provide more detailed driving information to the user. For example, according to the quantity of the intersections, the street intersections can be classified into dead end, dual-intersection, crossing, complex intersection, and traffic circle etc. When the vehicle travels to the crossing, the road scene is displayed on the screen, and the actual road situation pictures are used to assist the driving, so as to inform the driver that the road is a crossing, and it is necessary to be careful.

Accordingly, when it is determined that the vehicle is traveling to the street intersection currently, the satellite positioning navigator activates the digital lens to take the road scene, thereby updating the road scene information in the map database. In this embodiment, three methods of determining the vehicle is traveling to the street intersection exist.

First, the determination is performed according to moving distance. Generally, when the vehicle travels to the intersection, the speed is lowered, and when it is determined to be safe, the vehicle is made to turn or advance. Therefore, when the vehicle is static or when the driving distance is shorter than a predetermined distance, it can be determined that currently the vehicle is located in the street intersection, so as to activate the digital lens to take the road scene. In this embodiment, the coordinate positions received in three seconds (i.e., a time required to passing through a road with a width of 30 meters at a driving speed of 40 km/h) are used as reference, if the change of the coordinate positions is smaller than 20 meters (it is assumed that the street intersection is 20 meters), it represents that the driving speed is lowered, and it is possible that the vehicle is near or traveling to the street intersection.

Second, the determination is performed according to the traveling direction. An accelerometer or gyro is disposed in the satellite navigator to sense whether the traveling direction is changed. Generally, when the vehicle travels to the street intersection, if it intends to turn, it is necessary for the vehicle body to bear side (lateral) G force generated during turning. Therefore, the accelerometer and other elements for detecting acceleration of each direction are installed on the satellite navigator to measure whether the side (lateral) G force exists, so as to determine whether the traveling direction is changed, thereby determining that the vehicle is traveling to the street intersection currently and turning.

Third, the determination is performed according to the map database. Generally, it is impossible for the activated road to disappear without any reason. According to the information comprised in the map database corresponding to the coordinate position of the street intersection, it can be found whether the vehicle is traveling to the street intersection currently, that is to say, by looking up the street map according to the coordinate position of the street intersection, it can be found whether the vehicle is traveling to the street intersection.

It is notable that the first two methods of determining traveling to the street intersection are methods for forecasting whether the vehicle will travel to the street intersection. Although the first two methods can determine whether the position has the street intersection, it is possible to generate error. The third determining method uses the known map to determine that the vehicle is traveling to the street intersection, although the determining result is relatively precise, new street intersection may be not found. The street intersection is automatically found by combining the above three methods, and the human-machine interface or the acoustic control equipment is controlled to take the road scene or delete the road scene, such that the road scene of the street intersection is updated more accurately.

After determining that the vehicle is traveling to the street intersection, it begins to record each received set of coordinate positions till determining that the vehicle is traveling to a next street intersection. According to the plurality of coordinate positions received when traveling between two street intersections, a traveling route is recorded. By determining whether the map database has the traveling route (for example, determining whether all the coordinate positions of the traveling route are located on the road of the street map, if not, it is determined that “the traveling route does not exist”), it is determined whether the traveling route is a newly built road, so as to update the map database. In some embodiments, when it begins to record the received coordinate positions, the function of photoing the dynamic image of the digital camera is activated, so as to synchronously photo the dynamic images along the road, and to register the photoed images in register block of the satellite positioning navigator. Then, when it is determined that the traveling route is a newly built road to update the map database, the photoed dynamic images are stored in the map database. When the vehicle is driven to the position again, the dynamic images are played, for waking up driving memory to assist driving through the actual traveling images.

The updating of the traveling route is introduced as follows.

First, when it is determined that the street map does not include the recorded traveling route, it represents that the traveling route may be a newly-built road. At this time, the registered road scene is used to update the road scene information, and the quantity of the intersections of the road scene is used to determine that it is a dual-intersection, a crossing, or other types of intersections, so as to update the road type information. According to the traveling route, the street map of the map database is updated, i.e., the newly built road is drawn in the street map according to the traveling route.

Second, when it is determined that the street map includes the traveling route but does not store the road scene, the road scene information is updated according to the road scene, and at the same time, the type of the road scene information is determined to update the road type information.

Third, when it is determined that the street map includes the traveling route and the road scene, but the type of the road scene does not match with the stored road type information, then the road scene information and the road type information are updated according to the road scene and the road type.

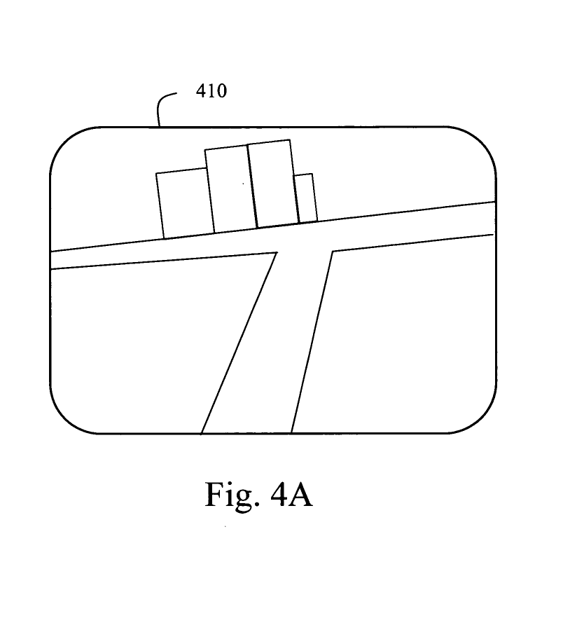

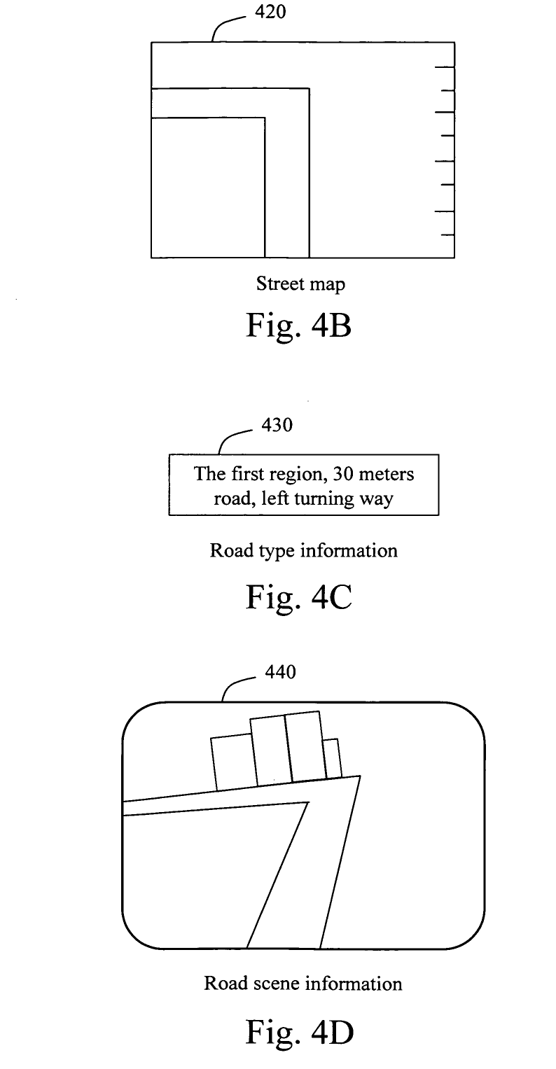

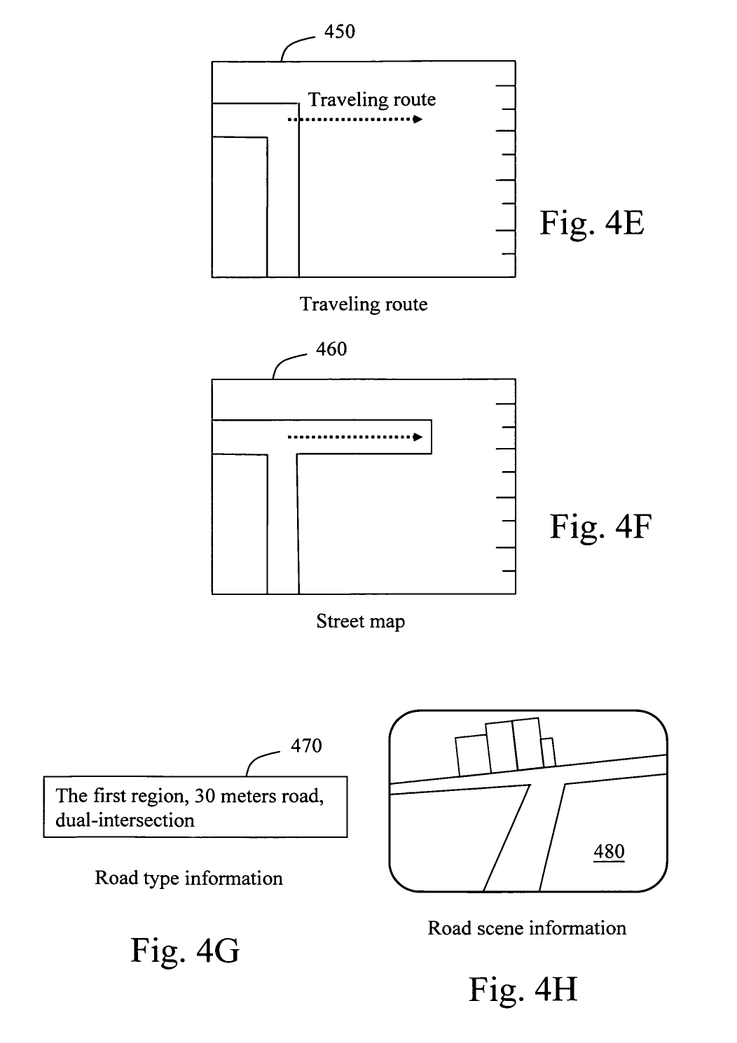

It should be noted that a newly built road connected to the old road could be known by using this method. In the map database, the recorded road type information of the end of the old road is a “dead end”. When the vehicle travels to the position, it is considered as traveling to a street intersection, at this time, it begins to record the coordinate position to record the traveling route, and the street map is updated after the newly built road is found. Next, an embodiment is used to illustrate the updating of the traveling route. FIG. 4A is a schematic view of the road scene took by the satellite positioning navigator according to a preferred embodiment of the present invention, FIG. 4B to 4D are schematic views of the map database corresponding to the coordinate position of the road scene of FIG. 4A, and FIG. 4E to 4H are schematic views of updating the database information of FIG. 4B to 4D according to the traveling route. Referring to FIGS. 4A, 4B to 4D, and 4E to 4H, when the vehicle travels to a first region intersection, the speed is lowered, at this time, a road scene 410 as shown in FIG. 4A is took (in this embodiment, the road scene 410 is for example, a static image, but it is not limited to the static image, and it can also be a dynamic audio/video file), the road scene 410 may be firstly stored in a register region. Next, the satellite positioning navigator reads the navigation information in the map database corresponding to the first region intersection, as shown in a street map 420 of FIG. 4B, a road type information 430 of FIG. 4C, and a road scene information 440 of FIG. 4D, and the navigation information is displayed on the screen. At this time, the satellite positioning navigator determines that the type of the road scene is a dual-intersection different from the left turning way recorded by the original road type information. At this time, the road type information 430 in the map database is stored in the register region.

After the satellite positioning navigator updates the map database, the navigation information after updating is displayed. At this time, the driver finds that a newly-built road exists on right side of the intersection and intends to have an examination. The vehicle turns right, and the satellite positioning navigator begins to record the received coordinate positions along the road. When the driver finds that it is the end of the newly built road, the driving is stopped. At this time, according to the received coordinate positions along the road, the satellite positioning navigator records a traveling route 450 of FIG. 4E, and after comparing the map database to find that the traveling route 450 does not exist, the satellite positioning navigator updates the street map, the traveling route is drawn in a street map 460 as shown in FIG. 4F. At this time, the road scene 410 stored in the register region is used to replace the road scene 440 originally stored in the map database, and the road scene information after being updated is as shown in a road scene information 480 of FIG. 4H. The road type information 430 is updated to be a road type information 470 as shown in FIG. 4G.

To sum up, in the present invention, according to the road scene took when the vehicle travels to the street intersection and the coordinate positions received between the street intersections, it is determined whether to update the map database, so as to find the newly built road on real time, and to maintain the accuracy of the map database. In addition, the took road scene (the dynamic image or the static image) can be combined with the map for the purpose of scene image navigation, when the vehicle drives to the position, the dynamic or the static image is displayed. The user can use the user interface to select the took road scene, so to inform that the selected road scene is which road section of which country, so as to draw the navigation path. Alternatively, the road scenes are added to point of interesting (POI) information, so as to establish private GPS scenes and maps. In the present invention, the driving course is used as the reference of updating map database, so it is not necessary to additionally connect a specific server, thereby preventing the complex procedure of updating the street map, and reducing time and money consumption.

What is claimed is:

1. A method of updating navigation map data comprised in a global positioning system (GPS) navigator having a digital camera module on real time, the method comprising:
receiving at least one GPS signal to obtain at least one corresponding coordinate position with movement of the global positioning system navigator;
taking at least one image of road scene when traveling to a street intersection is confirmed, and recording the coordinate position of the street intersection;
recording a traveling route comprising the image according to the coordinate positions received before traveling to a next street intersection; and
updating the map database according to the traveling route when the traveling route does not exist in the map database.

2. The method of updating navigation map data as claimed in claim 1, wherein the road scene is one selected from a set composed of photoed dynamic images and static images.

3. The method of updating navigation map data as claimed in claim 1, wherein the map database comprises a street map, road type information, and road scene information.

4. The method of updating navigation map data as claimed in claim 1, wherein traveling to the street intersection is confirmed by determining a change of the coordinate positions received in a predetermined time, when the change of the coordinate positions is smaller than a predetermined value, it is determined traveling to the street intersection.

5. The method of updating navigation map data as claimed in claim 1, wherein traveling to the street intersection is confirmed by an accelerometer or a gyro, when traveling direction change is sensed, it is determined traveling to the street intersection.

6. The method of updating navigation map data as claimed in claim 3, wherein the street intersection is determined through the predetermined street intersections recorded by the street map in the map database.

7. The method of updating navigation map data as claimed in claim 3, wherein the step of updating the map database according to the traveling route comprises:
when determining the street map does not comprise the traveling route, drawing the traveling route in the street map, and updating the road scene information according to the road scene.

8. The method of updating navigation map data as claimed in claim 1, wherein the step of updating the map database according to the traveling route comprises:
when determining the road scene information is not recorded on a coordinate of the street map corresponding to the coordinate position of the street intersection at which the road scene is took, updating the road scene information according to the road scene.

9. The method of updating navigation map data as claimed in claim 1, wherein the step of updating the map database according to the traveling route comprises:
analyzing a quantity of intersections in the road scene;
determining a type of the road scene through the quantity of the intersections; and
updating the map database according to the traveling route, the road scene, and the type of the road scene.

10. The method of updating navigation map data as claimed in claim 1, further comprising using a human-machine interface or an acoustic control equipment to adjust photographic angle of the digital lens, and recording the instruction voice corresponding to the road scene.

11. The method of updating navigation map data as claimed in claim 1, further comprising displaying the road type information and the road scene information, and playing the corresponding instruction voice when traveling to the street intersection.
